(19) United States
(12) Patent Application Publication
(10) Pub. No.: US 2026/0129236 A1
(43) Pub. Date: May 7, 2026

(54) HIGH LEVEL SYNTAX DESIGN FOR RULE-BASED QUANTIZATION TECHNIQUE FOR CONTENT CODED USING LEARNING-BASED METHODS

(71) Applicant: InterDigital VC Holdings, Inc., Wilmington, DE (US)

(72) Inventors: Gurdeep Bhullar, Montreal (CA); Dong Tian, Boxborough, MA (US); Jiahao Pang, Plainsboro, NJ (US)

(21) Appl. No.: 18/938,145

(22) Filed: Nov. 5, 2024

(51) Int. Cl. H04N 19/70; G06T 9/00

(52) U.S. Cl. CPC H04N 19/70; G06T 9/00

(57) ABSTRACT

Some embodiments of a method may include: obtaining a first bitstream comprising a plurality of encoded data samples; obtaining a second bitstream comprising a safeguard syntax structure; decoding the plurality of data samples; obtaining safeguard payload information from the safeguard syntax structure, wherein the safeguard payload information comprises a maximum tolerance error (MTE) and information regarding a set of risky samples; and performing a protection process on the decoded plurality of data samples using the safeguard payload information.

### INCORPORATION BY REFERENCE

The present application incorporates by reference in their entirety the following applications: U.S. Non-Provisional patent application Ser. No. 18/933,923, entitled “METHODS TO DESCRIBE THE HIGH-LEVEL SYNTAX DESIGN OF A BITSTREAM CARRYING DATA CODED USING LEARNING-BASED CODEC FOR POINT CLOUD CONTENT” and filed Oct. 31, 2024 (“923 application”); and U.S. Non-Provisional patent application Ser. No. 18/679,144, entitled “AN END-TO-END LEARNING-BASED POINT CLOUD CODING FRAMEWORK” and filed May 30, 2024 (“144 application”).

### BACKGROUND

The present application is related to syntax structure of bitfields.

### SUMMARY

A first example method in accordance with some embodiments may include: obtaining a first bitstream comprising a plurality of encoded data samples; obtaining a second bitstream comprising a safeguard syntax structure; decoding the plurality of data samples; obtaining safeguard payload information from the safeguard syntax structure, wherein the safeguard payload information comprises a maximum tolerance error (MTE) and information regarding a set of risky samples; and performing a protection process on the decoded plurality of data samples using the safeguard payload information.

For some embodiments of the first example method, the set of risky samples is a subset of the plurality of data samples.

For some embodiments of the first example method, the safeguard syntax structure comprises sample values for each member of a set of risky samples.

For some embodiments of the first example method, the safeguard syntax structure comprises a flag for each of the plurality of data samples, and each of the flags indicates whether the corresponding data sample is a member of the set of risky samples.

For some embodiments of the first example method, the safeguard syntax structure comprises a supplemental enhancement information (SEI) message.

For some embodiments of the first example method, the MTE applies to at least one of a sequence parameter set, a frame parameter set, a set of blocks, a block, a set of slices, and a slice corresponding to at least one of the plurality of data samples.

Some embodiments of the first example method may further include overriding the MTE with an override value based on a status parameter corresponding to at least one of the plurality of data samples.

For some embodiments of the first example method, the status parameter is an override flag.

For some embodiments of the first example method, performing the protection process on the decoded plurality of data samples comprises determining whether at least one of the decoded plurality of data samples is within the MTE for decoding.

For some embodiments of the first example method, performing the protection process on the decoded plurality of data samples changes a value of at least one of the plurality of data samples.

A first example apparatus in accordance with some embodiments may include: a processor; and a memory storing instructions operative, when executed by the processor, to cause the apparatus to: obtain a first bitstream comprising a plurality of encoded data samples; obtain a second bitstream comprising a safeguard syntax structure; decode the plurality of data samples; obtain safeguard payload information from the safeguard syntax structure, wherein the safeguard payload information comprises a maximum tolerance error (MTE) and information regarding a set of risky samples; and perform a protection process on the decoded plurality of data samples using the safeguard payload information.

A second example method in accordance with some embodiments may include: obtaining a plurality of data samples and information regarding a safeguard payload, wherein the safeguard payload information comprises a maximum tolerance error (MTE) and information regarding a set of risky samples; generating a transmitting the encoded plurality of data samples in a first bitstream; and transmitting the safeguard syntax structure in a second bitstream.

For some embodiments of the second example method, the set of risky samples is a subset of the plurality of data samples.

For some embodiments of the second example method, the safeguard syntax structure comprises sample values for each member of the set of risky samples.

For some embodiments of the second example method, the safeguard syntax structure comprises a flag for each of the plurality of data samples, and each of the flags indicates whether the corresponding data sample is a member of the set of risky samples.

For some embodiments of the second example method, the safeguard syntax structure comprises a supplemental enhancement information (SEI) message.

For some embodiments of the second example method, the MTE applies to at least one of a sequence parameter set, a frame parameter set, a set of blocks, a block, a set of slices, and a slice corresponding to at least one of the plurality of data samples.

Some embodiments of the second example method may further include overriding the MTE with an override value based on a status parameter corresponding to at least one of the plurality of data samples.

For some embodiments of the second example method, the status parameter is an override flag.

For some embodiments of the second example method, the plurality of data samples comprises a point cloud.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a data structure diagram illustrating an example bitstream structure according to some embodiments.

FIG. 3 is a process diagram illustrating an example protection of individual processes during decoding according to some embodiments.

FIG. 4 is a flowchart illustrating an example decoding process according to some embodiments.

FIG. 5 is a flowchart illustrating an example encoding process according to some embodiments.

FIG. 6 illustrates voxels in different levels.

FIG. 7 illustrates example octree encoding using a learning-based method, according to some embodiments.

FIG. 8 illustrates an example feature aggregator (FA) with aggregated feature as input, according to some embodiments.

FIG. 9 illustrates an example feature encoder using hyperprior encoder, according to an embodiment.

FIG. 10 illustrates an example occupancy probability estimator (in encoder and decoder), according to an embodiment.

FIG. 11 illustrates example octree decoding using a learning-based method, according to an embodiment.

FIG. 12 illustrates an example feature decoder using hyperprior decoder, according to an embodiment.

FIG. 13 illustrates feature-based coding in a larger codec system.

FIG. 14 illustrates an example octree coding in a larger codec system, according to an embodiment.

FIG. 15 illustrates another example octree coding in a larger codec system, according to an embodiment.

FIG. 16 illustrates an example FS block, according to an embodiment.

FIG. 17 is a process diagram illustrating an example coding framework with implicit hyperprior synthesis according to some embodiments.

FIG. 18 is a process diagram illustrating an example coding framework with explicit hyperprior data according to some embodiments.

FIG. 19 is a process diagram illustrating an example attribute encoding framework according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

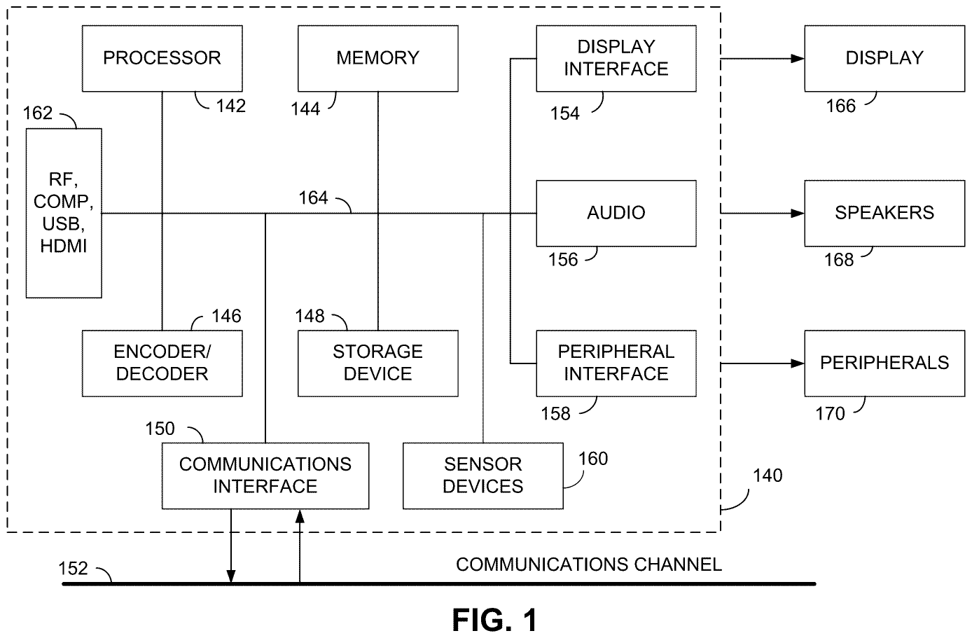

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

In learning-based system, the problem of reproducibility especially inference reproducibility exists. Typically, the same trained neural network model may produce results with minor differences on different hardware, such as different Graphic Processing Unit (GPUs) or different software platforms, such as PyTorch and TensorFlow. A major reason for irreproducibility is the non-determination by the platforms of when operations are executed in parallel, which is sensitive to computation orders.

### Reproducibility

Inference reproducibility is a well-known problem: neural network models may produce results with minor differences when they run on different hardware or software platforms, or when they run multiple times. One of the reasons is the implementation of some elementary functions used to build a neural network model, e.g., convolutional neural networks (CNNs), multi-perception layers (MLPs). When neural network models are used for entropy encoding and decoding, a slightly different output may be a severe problem for the entropy encoder and decoder. This scenario will not only output a different point cloud but may crash a decoding process. The '144 application discusses having an encoder generate a safeguard bitstream and having a decoder use the safeguard bitstream to reconstruct the same values as in the encoder. One example is shown of how this method may be used for deep octree coding for point cloud coding. Another example is shown for a hyperprior model, which may be applied for both learning-based point cloud coding and image/video coding.

### Learning-Based Point Cloud Compression

A point cloud content may be compressed such that the size of the resulting asset is reduced. The reduced size is beneficial for applications, such as transmission, streaming, and storage. With the advent of AI-methods and their use in compression, researchers have started to investigate methods to compress point cloud content using AI. With its popularity, MPEG 3DG WG07 has initiated a Call for Proposal (CfP) on the topic of AI-based Point Cloud Compression (AI-PCC). A functional design of a bitstream that corresponds to the architecture of the AI-PCC codec may be established.

The '144 application describes an architecture and method(s) to encode point clouds in a tree structure. The encoder uses a finer level of details to extract more powerful features. The extracted features are encoded into a bitstream to benefit the decoder. The decode decodes the features instead of computing them by itself.

The framework shares a backbone to code the features for both feature-based coding and octree-based coding. This results in a unified coding framework. The use of a unified backbone allows for simplicity and may result in wider adoption of the architecture. This may also result in a lower memory requirement.

### Bitstream Structure

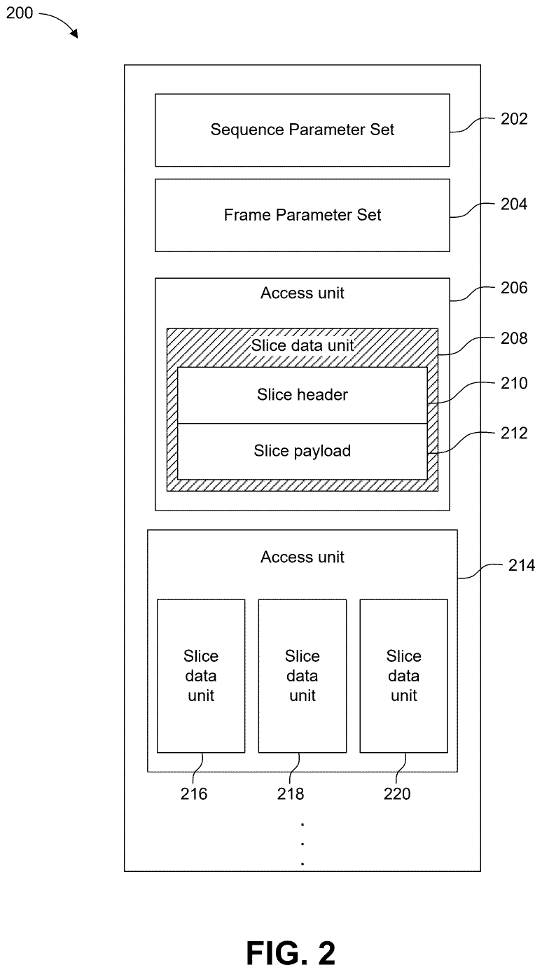

FIG. 2 is a data structure diagram illustrating an example bitstream structure according to some embodiments. A bitstream structure is described in the '923 application. The bitstream is designed to carry the learning-based coded data for point cloud content. The bitstream exhibits an architectural design to structure the bitstream. A slice with learning-based coded point cloud data, a sequence parameter set 202, and a frame parameter set 204 are contained in the bitstream structure 200. A bitstream may be composed of access units 206, 214. Each access unit 206, 214 carries the coded data for at least one slice. An access unit 206, 214 may carry multiple slices 216, 218, 220, which correspond to a particular composition time. An example bitstream structure 200 is shown in FIG. 2.

A slice stores data for a spatial region of the content. A slice is independently coding unit of a content coded using learning-based methods. A slice provides data for a spatial region of the content that it represents.

A slice_data_unit_rbsp( ) syntax structure is signaled by the encoder. Within the slice_data_unit_rbsp( ) syntax structure, information related to a particular slice (or slice data unit 208, 216, 218, 220) is stored. For some embodiments, a slice data unit 208 may include a slice header 210 and a slice payload 212. The slice_data_unit_rbsp( ) syntax structure has two entities slice_header( ) and slice_payload( ) The slice_header( ) provides metadata and or configuration information related to the coded slice in the payload. The slice_payload( ) includes the actual coded slide data. A slice_data_unit_rbsp( ) is defined as an RBSP syntax structure because using the RBSP syntax structure ensures strict bytes boundaries.

A slice payload 212 carries a coded representation of features for each depth level of a particular slice. The coded feature data from the feature encoder are coded using an arithmetic encoder. The learning-based encoder signals coded feature data for each depth level of a slice. For geometry representation of the point cloud content, the encoder may also signal octree occupancy information coded using an arithmetic coding engine. The octree occupancy data may be signaled up to a particular depth level.

Similarly, for attributes of the point cloud content, an encoder signals coded feature data. The encoder may signal coded attribute residual data, which may be used to generate a near lossless reconstruction of the attribute data of the point cloud.

### Null-Terminated String Syntax Descriptor

st(v) is a null-terminated string, which is encoded as UTF-8 characters in accordance with ISO/IEC 10646. The parsing process is specified as follows: st(v) begins at a byte-aligned position in the bitstream and reads and returns a series of bytes from the bitstream, beginning at the current position and continuing up to but not including the next byte-aligned byte that is equal to 0×00, and advances the bitstream pointer by (stringLength+1)*8 bit positions, where stringLength is equal to the number of bytes returned. The syntax descriptor is used in specification such as ISO/IEC 15938-17.

### Problem to be Solved

In a learning-based point cloud compression architecture, neural network models may produce results with minor different which may lead to differences in reconstruction of the coded content. In order to achieve exact or near exact reconstruction of the original content, a rule-based quantization scheme is described in this application.

In learning-based compression techniques, neural network models are used for entropy encoding and decoding. During the (en) coding and decoding processes, a slight difference in the output may be a severe problem for the entropy encoder and decoder. The output of the entropy encoding and decoding not only will be a different value but also may crash the decoding process. This application describes a high-level structure of a safeguard syntax structure, which is carried by a bitstream coded using learning-based methods. The safeguard structure may ensure a greater level of reproducibility.

This application describes methods of signaling with an encoder and methods a decoder may decode a syntax structure, which allows reproducibility of the output from a learning-based system of a codec architecture. A sample is a unit or coded representation of a sample to be protected by the safeguard mechanism. For example, in a point cloud, a sample is a point in a point cloud at a certain octree level/resolution. In a mesh, a sample is a mesh vertex/face vertex. In an image or video, a sample is a pixel or luma/chroma sample.

For some embodiments, the information carried includes a maximum tolerance error and either a set of risky samples or a flag indicating whether a sample belongs to the risky set. A first method describes a syntax structure carried within the bitstream to indicate the information. The syntax structure may be introduced at the sequence level, the frame level, and/or the slice level. A second method describes an SEI message carried by the bitstream to indicate the information.

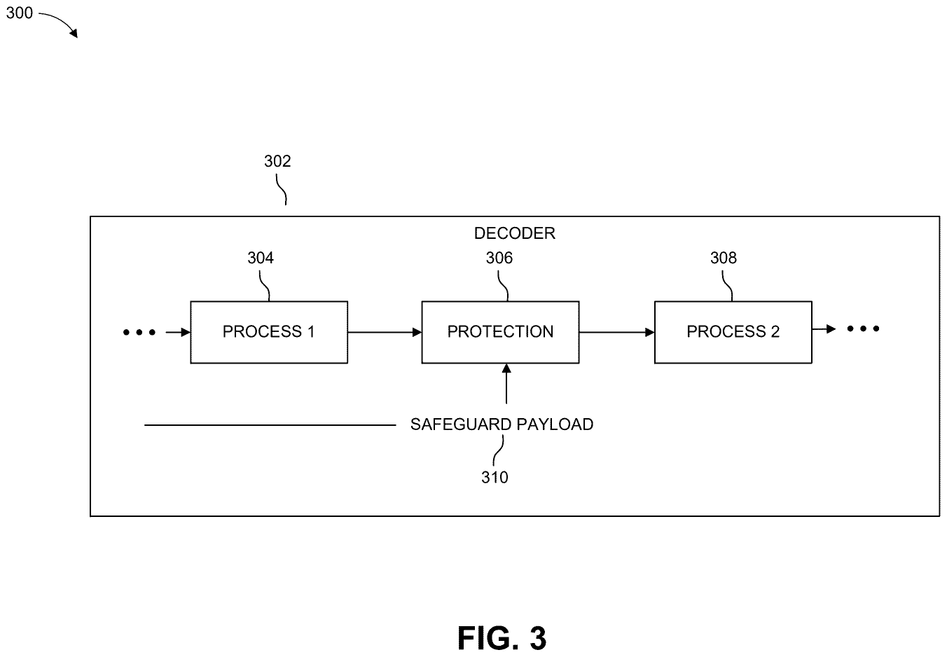

FIG. 3 is a process diagram illustrating an example protection of individual processes during decoding according to some embodiments. In some embodiments, coded data to be protected belongs to the output of a process within the decoder. In another words, the process itself may be protected. Before the output of the process may be used, the output data must be protected for some embodiments. A process also may be a tool used for decoding. In some embodiments, the output data from a process is to be used for entropy decoding of subsequent processes in the decoding pipeline. Therefore, protecting the output data of a process is crucial to ensure proper entropy decoding of the subsequent process in the decoding pipeline. For example, FIG. 3 illustrates a decoding pipeline 300 of a decoder 302. In the decoding pipeline, two processes exist namely Process 1 (304) and Process 2 (308). Process 1 (304) is identified to be protected by some means signaled in the bitstream. The output of Process 1 (304) is protected by a Protection operation 306 before sending the output data to Process 2 (308) in the line of decoding pipeline. The protection may be ensured by rule-based quantization to ensure that the subsequent decoding process or processes do not crash. For some embodiments, such protection 306 may use a safeguard payload 310.

To improve qualitive performance of the content, protection may be ensured after decoding in some embodiments. A protection mechanism is introduced as a post-decoding operation relative to the process to be protected to improve reconstruction of the coded content.

Some randomness may exist when the process is executed over AI hardware or platform for several different reasons. For example, the use of floating points, parallel processing, and misalignment in details of low-level implementations, among other reasons, may cause some of this randomness. Therefore, two major categories of reproducibility may be introduced: decoding reproducibility and reconstruction reproducibility.

Ensuring decoding reproducibility signifies that the decoding operation of processes within the decoding pipeline necessitates the use of safeguard data for some identified processes. Safeguard data is present for identified processes/tools. To ensure decoder conformance, safeguard data may be used to generate a final output from the identified processes/tools. Failing to signal/decode safeguard data may result in a decoder crash.

Ensuring reconstruction reproducibility signifies that the reconstruction operation of the process in the reconstruction pipeline may use safeguard data for some identified processes. The use of safeguard is optional. Decoder will not crash if safeguard data for reconstruction is not signaled by the encoder. However, the enforcement of reconstruction reproducibility may ensure a full reconstruction conformance.

The process/tool to be protected may be identified by signaling syntax elements in the bitstream. The syntax elements may be present in the sequence level, frame level, and/or slice/picture header level. Typically, such syntax elements are coded as Boolean values indicating whether some processes/tools are protected. The syntax elements are constrained by the profile definition in the bitstream. Thereby, a decoder conforming to a particular profile of the bitstream may protect the processes/tools using the safeguard data signaled in the bitstream.

For example, in learning-based point cloud compression, a slice geometry header may indicate the process/tools that are to be protected by the decoder while decoding the slice payload. A syntax element, such as sgh_feature_for_occupancy_protected_enabled_flag, indicates whether the feature coded data is protected. Since feature coded data is used to decode occupancy data, protection for feature coded data may be ensured to decode octree occupancy during the entropy decoding process of the octree occupancy data.

In some embodiments, protection of feature coded data is enabled up to a specific octree depth level. To facilitate such cases, a syntax element, sgh_feature_for_occupancy_protected_depth_level_index, is signaled by the encoder or decoded by the decoder to be able to expect safeguard payload for the feature coded data up to the depth level indicated by sgh_feature_for_occupancy_protected_depth_level_index. See Table 1.

TABLE 1

| Code | Descriptor |
|---|---|
| slice_geometry_header( ) { | |
| . . . | |
| sgh_feature_for_occupancy_protected_enabled_flag | u(1) |
| if (sgh_feature_for_occupancy_protected_enabled_flag) { | |
| sgh_feature_for_occupancy_protected_depth_level_index | u(8) |
| } | |
| . . . | |
| } | |

In terms of bitstream, for processes/tools which are deemed protected, after the parsing and processing the data from the tools, a safeguard payload is indicated to protect the output of the process/tool. The safeguard payload is carried in the slice/picture payload containing information related to samples of the coded representation of the content. Some examples of safeguard payload are described below.

### Maximum Tolerance Error

A syntax element, which is signaled by the encoder or decoded by the decoder, determines the maximum tolerance error for the samples within the bitstream. The maximum tolerance may be determined at the local level of the samples, e.g., slice or block level, or may be determined at a higher or global level of the sample, e.g., frame parameter set or sequence parameter set level. With maximum tolerance error indicated by the sequence parameter set, the maximum tolerance error (MTE) remains consistent across all frames and subsequently all slices/blocks associated with the sequence. Finer control may be achieved by signaling the MTE in the frame parameter set and/or slice header. An MTE signaled in the frame parameter set may be applicable to multiple slices. An MTE signaled in a slice header may be applicable to a slice, which provides slice-level control over the MTE.

The MTE may be coded using float point integer or a fixed-point integer in the bitstream. In this document, floating point numbers are used. In some embodiments, the MTE may be coded using fixed-point integers. In some embodiments, the MTE signaled at each level (sequence, frame, and slice level) may be an absolute value of the maximum tolerance error.

TABLE 2

| Code | Descriptor |
|---|---|
| sequence_parameter_set( ) { | |
| . . . | |
| sps_absolute_mte | fl(64) |
| } | |

The final MTE used to decode the slice/process output in slice payload is shown in Eq. 1:

$$MTE for payload in the slice = sps\_absolute \_mte \qquad ( 1 )$$

A syntax element (for example, sps_offset_mte) is signaled in the sequence parameter set, which specifies the absolute value for the maximum tolerance error for a sequence of coded point cloud frames. See Table 2. The syntax element sps_offset_mte is used to decode the slice payload. The maximum tolerance error also may be signaled at the frame level or slice header, whereby the value indicated by the sequence parameter set is overridden.

TABLE 3

| Code | Descriptor |
|---|---|
| Frame_parameter_set( ) { | |
| . . . | |
| fps_mte_override_flag | u(1) |
| if (fps_mte_override_flag) { | |
| fps_absolute_mte | fl(64) |
| } | |
| } | |

The final MTE to decode the slice/process output in slice payload is shown in Eq. 2:

$$MTE for payload in the slice = fps\_absolute \_mte \qquad ( 2 )$$

A syntax element (for example, fps_mte_override_flag) is signaled by the encoder or decoded by the decoder in the frame parameter set. See Table 3. The syntax element specifies whether the maximum tolerance error is signaled in the frame parameter set. Slices that correspond to the frame parameter set with fps_mte_override_flag equal to 1 use the value indicated by fps_absolute_mte to decode the slice payload. Slices that correspond to the frame parameter set with fps_mte_override_flag equal to 0 use the value indicated by sps_absolute_mte to decode the slice payload. A syntax element (for example, fps_offset_mte) is signaled in the frame parameter set, which specifies the absolute value of the maximum tolerance error for the point cloud frame.

A much finer level of granularity may be achieved by signaling the MTE at the slice level. Samples contained in the slice may be subjected to the MTE within the local scope of the slice boundary. For example, for point cloud compression, an MTE may be indicated in the slice geometry header for the coded geometry data. Also, an MTE may be indicated in the slice attribute header for the coded attribute data carried in the payload.

TABLE 4

| Code | Descriptor |
|---|---|
| Slice_geometry_header( ) { | |
| . . . | |
| sgh_mte_override_flag | u(1) |
| if (sgh_mte_override_flag) { | |
| sgh_absolute_mte | fl(64) |
| } | |
| } | |

The final MTE to decode the slice/process output in slice geometry payload is shown in Eq. 3:

$$MTE for payload in the geometry slice = sgh\_absolute \_mte \qquad ( 3 )$$

A syntax element (for example, sgh_mte_override_flag) is signaled by the encoder or decoded by the decoder in the slice geometry header. See Table 4. The syntax element specifies whether the maximum tolerance error is signaled in the slice geometry header. If the maximum tolerance error is signaled in the slice geometry header (the value of sgh_mte_override_flag is 1), the maximum_tolerance_error from the slice geometry header is used to decode the slice payload.

Slices with sgh_mte_override_flag equal to 0 use the value indicated by fps_absolute_mte to decode the slice payload if fps_mte_override_flag is 1. Slices with sgh_mte_override_flag equal to 0 use the value indicated by sps_absolute_mte to decode the slice payload if fps_mte_override_flag is 0.

TABLE 5

| Code | Descriptor |
|---|---|
| slice_attribute_header( ) { | |
| . . . | |
| sah_mte_override_flag | u(1) |
| if (sah_mte_override_flag) { | |
| sah_absolute_mte | fl(64) |
| } | |
| } | |

The final MTE to decode the slice/process output in slice attribute payload is shown in Eq. 4:

$$MTE for payload in the attribute slice = sah\_absolute \_mte \qquad ( 4 )$$

A syntax element (for example, sah_mte_override_flag) is signaled by the encoder or decoded by the decoder in the slice attribute header. See Table 5. The syntax element specifies whether the maximum tolerance error (MTE) is signaled in the slice attribute header. If the maximum tolerance error is signaled in the slice attribute header (the value of sah_mte_override_flag is 1), the maximum_tolerance_error signaled in the slice attribute header (the value of sah_absolute_mte) is used to decode the slice payload.

Slices with sah_mte_override_flag equal to 0 use the value indicated by fps_absolute_mte to decode the slice payload if fps_mte_override_flag is 1. Slices with sah_mte_override_flag equal to 0 use the value indicated by sps_absolute_mte to decode the slice payload if fps_mte_override_flag is 0.

For some embodiments, the MTE signaled at each level in the bitstream may indicate a relative value of the maximum tolerance error. For example, an initial MTE is signaled by the sequence parameter set, which is applicable to all samples in the coded representation. Subsequently, relative to the MTE signaled in the sequence parameter set, an MTE is signaled in the frame parameter set. Similarly, relative to the MTE signaled in the frame sequence, an MTE value is signaled in the slice header.

TABLE 6

| Code | Descriptor |
|---|---|
| sequence_parameter_set( ) { | |
| . . . | |
| sps_intial_mte | fl(64) |
| } | |

A syntax element (for example, sps_initial_mte) is signaled in the sequence parameter set, which specifies the initial value for the maximum tolerance error for the sequence of coded point cloud frames. See Table 6. The sps_initial_mte is used to decode the slice payload. The maximum tolerance error also may be signaled at the frame level or slice header, whereby the value indicated by the sequence parameter set is used as an offset.

TABLE 7

| Code | Descriptor |
|---|---|
| frame_parameter_set( ) { | |
| . . . | |
| fps_mte_present_flag | u(1) |
| if (fps_mte_present_flag) { | |
| fps_delta_mte | fl(64) |
| } | |
| } | |

A syntax element (for example, fps_mte_present_flag) is signaled by the encoder or decoded by the decoder in the frame parameter set. See Table 7. The syntax element specifies whether the delta value of the maximum tolerance error is signaled in the frame parameter set.

Slices that correspond to the frame parameter set with fps_mte_present_flag equal to 1 use the value calculated by the addition of the value indicated in the sps_initial_mte syntax element and the value indicated in the fps_delta_mte to decode the slice payload. Slices that correspond to the frame parameter set with fps_mte_present_flag equal to 0 use the value indicated by sps_intial_mte to decode the slice payload.

A syntax element (for example, fps_delta_mte) is signaled in the frame parameter set, which specifies the delta value for the maximum tolerance error for the point cloud frame relative to the value indicated in the syntax element sps_initial_mte.

The final MTE to decode the slice/process output in slice payload is calculated as shown in Eq. 5:

$$MTE = sps\_initial \_mte + if ( fps\_mte \_present \_flag ) \{ fps\_delta \_mte \} \qquad ( 5 )$$

A much finer level of granularity may be achieved by signaling the MTE at the slice level. Samples contained in the slice may be subjected to the MTE within the local scope of the slice boundary.

For example, for point cloud compression, an MTE may be indicated in the slice geometry header for the coded geometry data. Additionally, an MTE may be indicated in the slice attribute header for the coded attribute data carried in the payload.

TABLE 8

| Code | Descriptor |
|---|---|
| slice_geometry_header( ) { | |
| . . . | |
| sgh_mte_present_flag | u(1) |
| if (sgh_mte_present_{——}flag) { | |
| sgh_delta_mte | fl(64) |
| } | |
| } | |

A syntax element (for example, sgh_mte_present_flag) is signaled by the encoder or decoded by the decoder in the slice geometry header. See Table 8. The syntax element specifies whether the delta of the maximum tolerance error is signaled in the slice geometry header.

If the maximum tolerance error is signaled in the slice geometry header (the value of sgh_mte_present_flag is 1), the maximum_tolerance_error (MTE) signaled in the slice geometry header is calculated by the addition of: (1) the value indicated in the fps_delta_mte if fps_mte_present_flag is 1, (2) the value indicated in the sps_initial_mte, and (3) the value indicated in the sgh_delta_mte syntax element to decode the slice payload.

Slices with sgh_mte_present_flag equal to 0 use the value calculated by the addition of the value indicated by sps_inital_mte and the value indicated by fps_delta_mte if fps_mte_present_flag is 1 to decode the slice payload.

Slices with sgh_mte_present_flag equal to 0 use the value indicated by sps_initial_mte if fps_mte_present_flag is 0 to decode the slice payload.

The final MTE to decode the slice/process output in the slice geometry payload is calculated as shown in Eq. 6:

$$MTE = sps\_initial \_mte + if ( fps\_mte \_present \_flag ) \{ fps\_delta \_mte \} + if ( sah\_mte \_present \_flag ) \{ sah\_delta \_mte \} \qquad ( 6 )$$

TABLE 9

| Code | Descriptor |
|---|---|
| slice_attribute_header( ) { | |
| . . . | |
| sah_mte_present_flag | u(1) |
| if (sah_mte_present_{——}flag) { | |
| sah_delta_mte | fl(64) |
| } | |
| } | |

A syntax element (for example, sah_mte_present_flag) is signaled by the encoder or decoded by the decoder in the slice attribute header. See Table 9. The syntax element specifies whether the delta of the maximum tolerance error is signaled in the slice attribute header.

The final MTE to decode the slice/process output in the slice attribute payload is calculated as shown in Eq. 7:

$$MTE = sps\_initial \_mte + if ( fps\_mte \_present \_flag ) \{ fps\_delta \_mte \} + if ( sah\_mte \_present \_flag ) \{ sah\_delta \_mte \} \qquad ( 7 )$$

The value of max_tolerance_error is determined at the encoder end as a function of a list of factors. Such factors may include: AI hardware/platform and implementation details of the encoder and the targeted decoder; and the dataset to be encoded/decoded.

Since the value may depend on point cloud data at a higher level (e.g., at the sequence level), the value of max_tolerance_error tends to be larger due to larger variance in the data. The coding performance will be more sacrificed when using a larger value of max_tolerance_error. If the max_tolerance_error is signaled at the frame or slice level, the value of max_tolerance_error may be specific to the coded frame or coded slice rather than the global/sequence level value indicated for max_tolerance_error. Hence, the max_tolerance_error may be more precisely chosen for a coded frame or a coded slice, thereby leading to less compromise on coding performance.

The max_tolerance_error is determined for an encoder-decoder pair. The information about the encoder-decoder pair may be signaled in the profile of the bitstream. Alternatively, this information may be signaled with a SEI message.

### Rule-Based Quantization for Point Cloud

Per the '144 application, a sample is termed risky or requiring extra care with additional metadata when the value of the sample is close to its ceiling within the maximum tolerable error for decoding.

For point cloud compression, a slice data structure is introduced in the '923 application. The point cloud geometry is structured into an octree. The number of voxels carried in a slice per hierarchical level may be determined based on the input point cloud geometry.

Depending on the process/tools indicated by the slice header or higher-level syntax structure in the bitstream, such as a sequence parameter set and a frame parameter set, an encoder may signal or a decoder may decode the coded slice syntax structure. The coded slice syntax structure includes a syntax element, which indicates binary flag values for each sample in the coded representation of the content. For example, for a point cloud, a binary flag may exist for every voxel at each hierarchical level.

For some embodiments, a bitstream coded using learning-based point cloud compression technique may indicate the output of feature coded data at each depth level to be protected. This indication may be signaled in the slice header by a syntax element (such as sgh_feature_all_protected_enabled_flag). This kind of safeguard payload is used to ensure decoding reproducibility since the feature data is used with entropy decoding of the octree occupancy data. In the slice payload, the payload carries safeguard data for the feature data at each depth level. In such a case, the safeguard data carries the information to run a rule-based quantization method on the feature coded data.

TABLE 10

| Code | Descriptor |
|---|---|
| slice_geometry/attribute_payload( ) { | |
| for (depthIdx=0; depthIdx<slice_depth_minus1; | |
| depthIdx++) { | |
| . . . | |
| if (sgh_feature_all_protected_enabled_flag && | |
| feature_coding_enabled_flag) { | |
| slice_payload_points_in_mte_boundary_flag [depthIdx] | ae(v) |
| } | |
| . . . | |
| } | |
| . . . | |
| } | |

A syntax element (for example, slice_payload_points_in_mte_boundary_flag) carries an array of u (1) values for every voxel at each hierarchical level. See Table 10. A lot of points fall outside of the maximum tolerance error boundary. Therefore, for many points in the slice, the value is coded as 0 since the points do not require any additional care for reconstruction. Therefore, coding the syntax element with arithmetic coding results in a smaller coded output for some embodiments. The number of bins required for the arithmetic operation depends on the number of voxels in a slice per hierarchical level.

In some embodiments, a learning-based point cloud encoder may signal safeguard data for the feature payload up to a certain depth level. This kind of safeguard payload is used to ensure decoding reproducibility since the feature data is used to execute the entropy decoding of the octree occupancy data. In this case, the safeguard data carries the information to run the rule-based quantization method on the feature coded data up to a specific depth level.

TABLE 11

| Code | Descriptor |
|---|---|
| Slice_geometry/attribute_payload( ) { | |
| for (depthIdx=0; depthIdx<slice_depth_minus1; depthIdx++) | |
| { | |
| . . . | |
| if (feature_coding_enabled_flag && | |
| sgh_feature_for_occupancy_protected_enabled_flag && | |
| depthIdx< | |
| sgh_feature_for_occupancy_protected_depth_level_index) | |
| { | |
| slice_feature_for_occupancy_protected_payload_flag | ae(v) |
| [depthIdx] | |
| . . . | |
| } | |
| . . . | |
| } | |

In some embodiments, a learning-based point cloud encoder may signal safeguard data (for example, slice_protected_payload_flag) for the entire coded slice. This kind of safeguard payload may be used to ensure reconstruction reproducibility. In this case, the decoding of the slice data may not crash as the protection is applied after the decoding of the entire slice data over different depth levels. Since the entire slice payload is protected from end-to-end, this methodology may lead to safeguard data carrying more information and resulting in a significant increase in the bitrate.

TABLE 12

| Code | Descriptor |
|---|---|
| Slice_geometry/attribute_payload( ) { | |
| for (depthIdx=0; depthIdx<slice_depth_minus1; | |
| depthIdx++) | |
| . . . | |
| } | |
| slice_protected_payload_flag | ae(v) |
| } | |

Rule-based quantization happens on both the encoder and the decoder sides to align the outputted values from a computing process to be protected. Hence, the coded bitstream differs for different levels (or values) of max_tolerance_error.

### Signaling Encoder/Decoder Pair Information

The maximum tolerance error depends on the hardware/software implementation chosen for encoder and decoder pair. Some information indicating the hardware/software implementation used for the encoder and decoder pair is signaled in the form of a Uniform Resource Identifier (URI). The URI identifies the hardware encoder/decoder pair used to determine the value of some syntax elements in the bitstream. For example, the value of max_tolerance_error depends on the encoder/decoder pair as described above. The URI also enables establishing of interoperability points among individual encoder/decoder pair implementations.

A central registry is managed by a registration authority outside the scope of the specification which contains information on encoder/decoder pair. Each element in the central registry is identified by a URI. Within the bitstream, the URI of the encoder/decoder pair may be identified using the profile signaled. Alternatively, the URI may be signaled in an SEI message with bitstream carrying learning-based coded representation of point cloud.

### Profile Indicating Encoder/Decoder Pair URI

A syntax element is introduced in the profile syntax structure of the bitstream. A syntax element named for example ptl_codec_pair_information_uri indicates a URI string which shall be encoded as UTF-8 characters in accordance with ISO/IEC 10646. The indicated URI string is a registered URI from the central registration authority.

TABLE 13

| Code | Descriptor |
|---|---|
| profile( ) { | |
| . . . | |
| ptl_codec_pair_information_uri | st(v) |
| . . . | |
| } | |

### SEI Indicating Encoder/Decoder Pair URI

A supplemental enhancement information (SEI) message is introduced to indicate the URI which provides the information on the encoder/decoder pair. An SEI message (for example, a Codec_Pair_Information (CPI) SEI message) carries information regarding the codec pair that is used to decode the bitstream. A syntax element, such as cpi_codec_pair_information_uri, indicates a URI string that is used to identify the codec pair. The URI string is encoded as UTF-8 characters in accordance with ISO/IEC 10646. The indicated URI string is a registered URI from the central registration authority.

An extension mechanism is also introduced within the CPI SEI message to carry additional information related to the codec pair.

TABLE 14

| Code | Descriptor |
|---|---|
| codec_pair_information( ) { | |
| cpi_codec_pair_information_uri | st(v) |
| cpi_extension_8_bits | u(8) |
| if (cpi_extension_8_bits) { | |
| cpi_extension_data | u(8) |
| } | |
| } | |

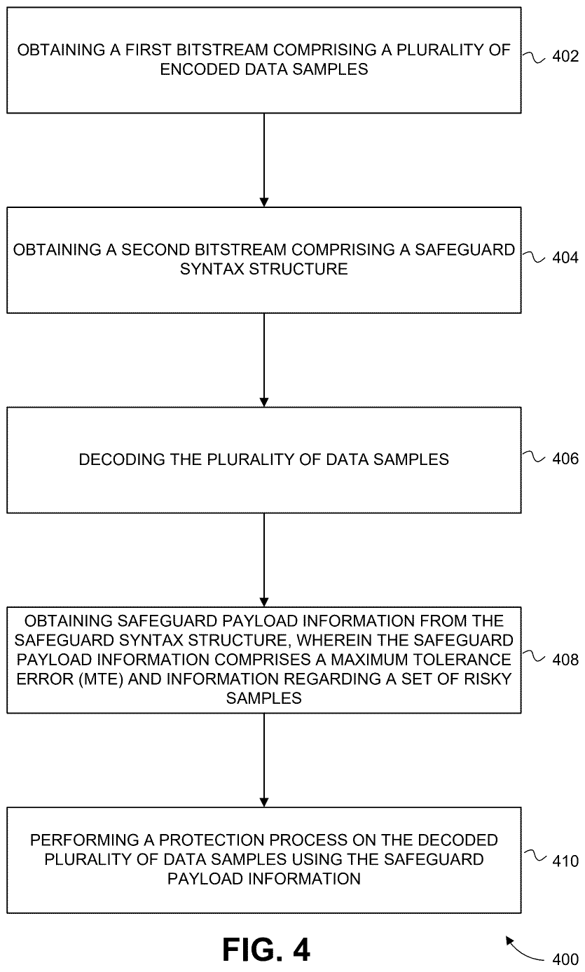

FIG. 4 is a flowchart illustrating an example decoding process according to some embodiments. For some embodiments, an example process 400 may include obtaining 402 a first bitstream comprising a plurality of encoded data samples. For some embodiments, the example process 400 may further include obtaining 404 a second bitstream comprising a safeguard syntax structure. For some embodiments, the example process 400 may further include decoding 406 the plurality of data samples. For some embodiments, the example process 400 may further include obtaining 408 safeguard payload information from the safeguard syntax structure, wherein the safeguard payload information comprises a maximum tolerance error (MTE) and information regarding a set of risky samples. For some embodiments, the example process 400 may further include performing 410 a protection process on the decoded plurality of data samples using the safeguard payload information.

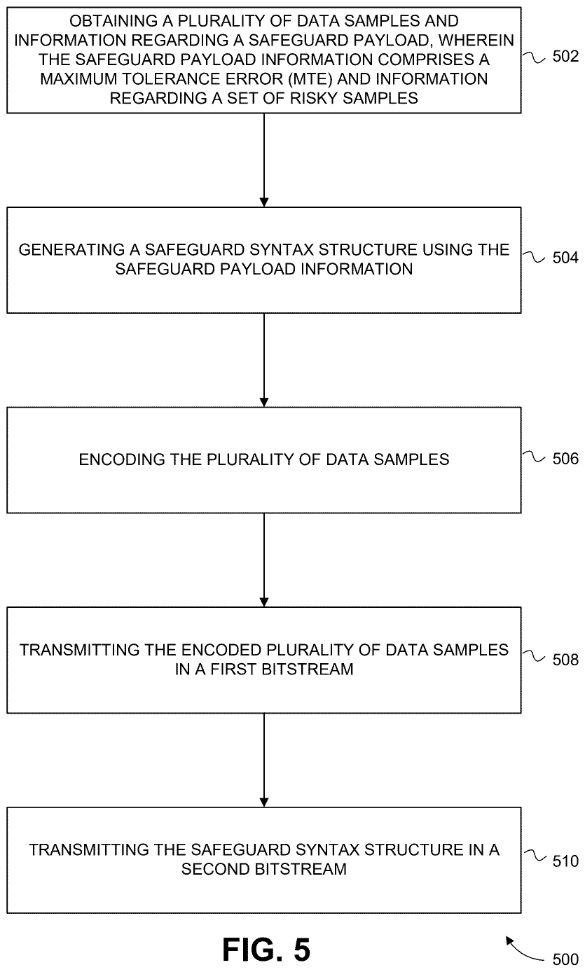

FIG. 5 is a flowchart illustrating an example encoding process according to some embodiments. For some embodiments, an example process 500 may include obtaining 502 a plurality of data samples and information regarding a safeguard payload, wherein the safeguard payload information comprises a maximum tolerance error (MTE) and information regarding a set of risky samples. For some embodiments, the example process 500 may further include generating 504 a safeguard syntax structure using the safeguard payload information. For some embodiments, the example process 500 may further include encoding 506 the plurality of data samples. For some embodiments, the example process 500 may further include transmitting 508 the encoded plurality of data samples in a first bitstream. For some embodiments, the example process 500 may further include transmitting 510 the safeguard syntax structure in a second bitstream.

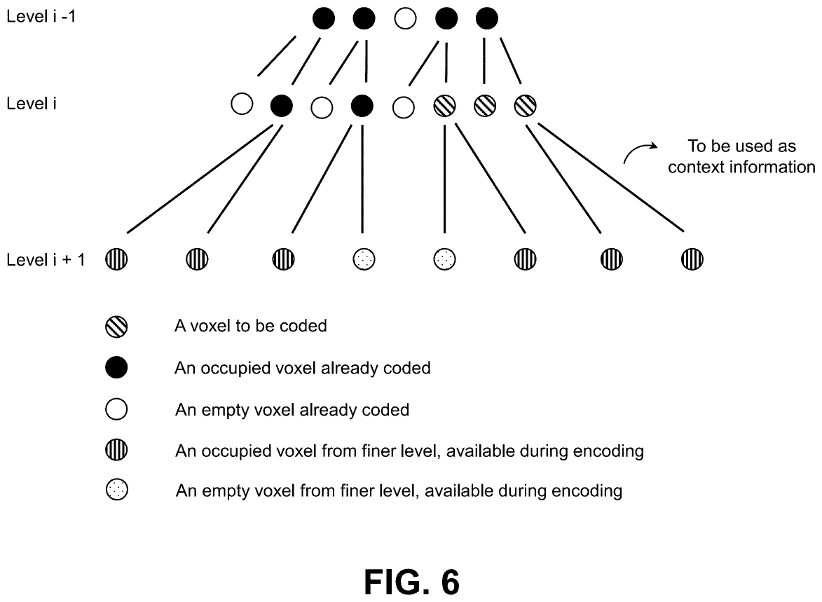

FIGS. 6-16 presented below provide non-limiting examples adapted from the '144 application. The following examples are adapted and presented from the '144 application, incorporated herein by reference, for explanatory purposes.

### Learning-Based Point Cloud Compression

Since point cloud data is composed of two components: geometry information and attribute information, the compression of point clouds may be classified into two categories: geometry coding and attribute coding.

Examples of existing learning-based point cloud geometry compression techniques are deep octree coding, end-to-end feature-based geometry coding. With deep octree coding, neural network-based models are utilized to estimate the occupancy probabilities. Such estimated probabilities are then used to help the arithmetic coder (or other entropy coder) to encode or decode a binary flag indicating whether a child octree voxel is occupied or empty.

In an octree-based representation, the whole space, i.e., a 3D bounding box, is recursively split into an octree structure to represent a point cloud. If the bounding box has a scale of 1×1×1, an octree leaf node corresponds to a point with a size equal to 1/(2^{d})×1/(2^{d})×1/(2^{d}), where index d represents the depth level in the octree counted from 0.

In an octree decomposition tree, the root node covers the whole 3D bounding box. The 3D space is equally split in every direction, i.e., x-, y-, and z-directions, leading to eight (8) voxels. For each voxel, if there are at least one point in it, the voxel is marked to be occupied, represented by ‘1’; otherwise, it is marked to be empty, represented by ‘0’. The octree root node is then described by an 8-bit integer number indicating the occupancy information.

To move from an octree level to the next, the space of each occupied voxel is further split into eight (8) child voxels in the same manner. If occupied, each child voxel is further represented by an 8-bit integer number. The splitting of occupied voxels continues until the last octree depth level is reached. The leaves of the octree finally represent the point cloud.

In accordance with presented examples, the encoding/decoding does proceed from the root level all the way down to the leaf level, i.e., it is overall still a top-down strategy. However, as, in accordance with some examples presented, the octree voxel occupancy probability is estimated using finer level of details, it is a bottom-up strategy for the encoding/decoding of each individual level. In the example methods of coding the tree structures for a point cloud, the encoder not only encodes occupancy information into the bitstream, but also encodes features, which are extracted/aggregated based on information from the finer levels of the octree, into the bitstream. Such features are used to assist the encoder to perform the arithmetic coding of the octree occupancy information. In the example method, the decoder first decodes the feature, and then decodes the octree occupancy information based on the decoded feature.

### An Example Encoding Method

FIG. 6 illustrates a portion (level i−1, i, i+1) of an octree to be coded. In FIG. 6, we use a binary tree representing an octree for a point cloud for the purpose of simplifying the drawing. A solid point represents an occupied octree voxel, that has been already encoded or decoded. A circle point represents a non-occupied or empty octree voxel, that has been already encoded or decoded. A circle with diagonal shading represents the octree voxels to be encoded or decoded.

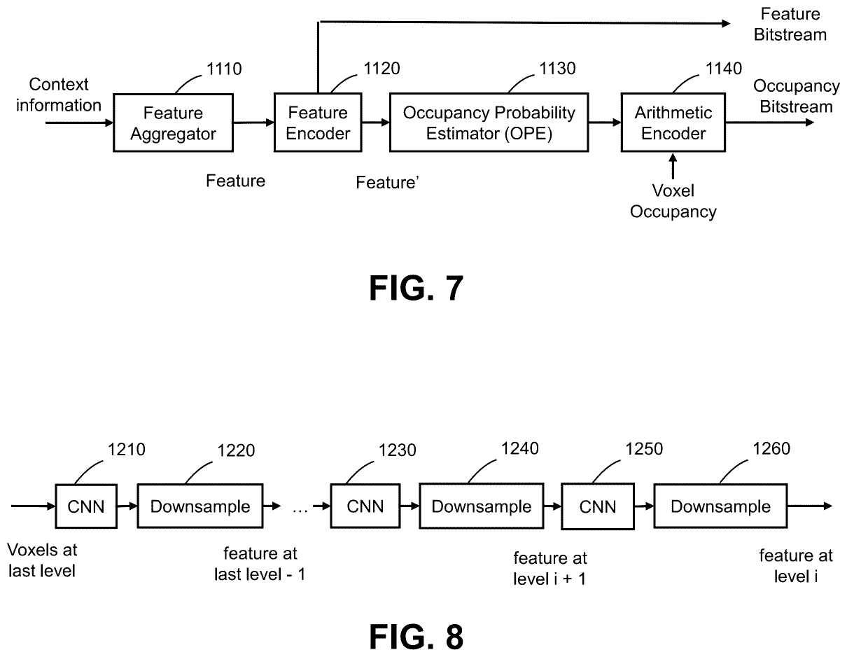

FIG. 7 illustrates an example encoding method, according to some embodiments. The example method of FIG. 7 also encodes features as well as octree occupation information.

The example feature extractor/aggregator (1110) uses the finer (child) level of details, or the complete current level (including those voxels that have not been encoded/decoded) as its input. Because the finer level of voxels or the complete current level always have more detailed information comparing to voxels from a parent level, it is much easier to extract more representative features.

Because the feature is extracted based on the finer or current level of voxels that are not yet coded, the extracted feature needs to be signaled in the bitstream. The feature generated by the feature aggregator (1110) is encoded into bitstream by a feature encoder FE (1120). In addition to generating the bitstream, the feature encoder also outputs the reconstructed feature, that may not be exactly the same as the feature from the feature aggregator (1110). The reconstructed feature should match the decoded feature on a decoder.

The occupancy probability estimator (OPE) uses a neural network model to estimate occupancy probabilities of the voxels to be encoded. It takes the reconstructed feature as its input and computes (1130) the occupancy probability of a current octree voxel. Based on the estimated probability, the arithmetic encoder (1140) will encode the occupancy information of the current octree voxel into a bitstream. In the figure, two separate bitstreams are shown for the occupancy and feature. Alternatively, they may be multiplexed into one bitstream.

### Feature Aggregator (1110)

An example feature aggregator (FA) is shown in FIG. 8 in accordance with some embodiments. The feature extraction and aggregation start from the finest level of octree. The aggregated feature undergoes a deeper network to propagate the feature all the way from the finest level to the current level.

In accordance with some embodiments, the feature aggregator (FA), includes several 3D convolutional neural network (CNN) blocks (1210, 1230, 1250) followed by downsampling (1220, 1240, 1260). The CNN module is simply composed of a series of back-to-back 3D convolutional layers with ReLU activation function appended after each convolutional layer to introduce non-linearity to the feature aggregation process. The “Downsample” blocks are to gradually downsample the feature from the last (finest) level to the i-th level. In more advanced embodiments, the CNN blocks may be replaced with other commonly used feature aggregation blocks, such as an Inception ResNet (IRN) block, and a Transformer block, and these blocks may be repeated several times to enhance the feature aggregation performance.

More generally, the feature aggregation may be based on any number of finer levels as well as the complete current level (including those voxels that have not been encoded/decoded) in the octree.

### Feature Encoder (1120)

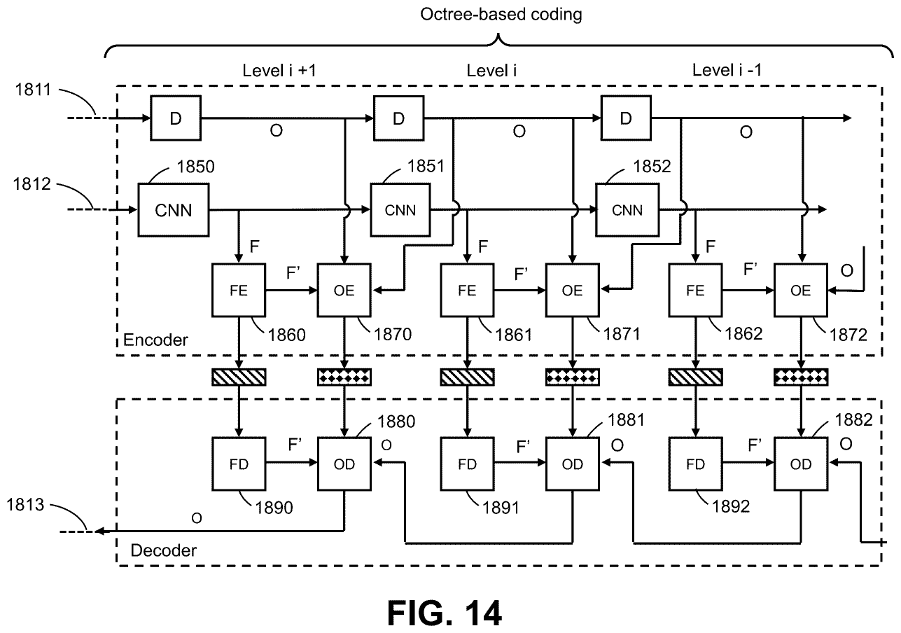

An example feature encoder (FE) is shown in FIG. 14 in accordance with some embodiments. The example feature encoder employs the hyperprior encoder. A purpose of this example design is to analyze and utilize the distribution of the feature so as to perform efficient arithmetic coding of the feature.

The input feature is sent to a “hyperprior analysis” module (1310) to aggregate a hyperprior feature that is more abstract than the input feature. The hyperprior feature is much easier to be encoded. It is used to compute the hyperprior parameters later. The hyperprior features are encoded (1320) into a hyperprior bitstream, that may undergo some quantization first and arithmetic encoding.

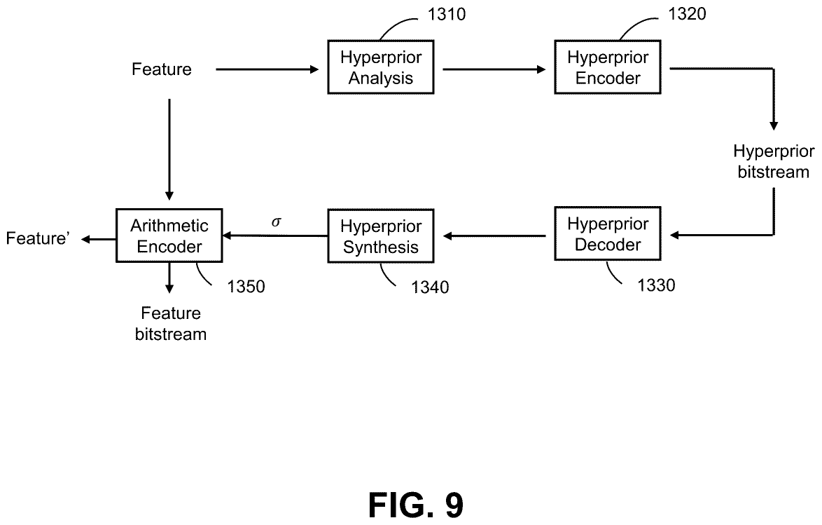

The hyperprior bitstream is arithmetically decoded and dequantized (1330) to output a reconstructed hyperprior feature. The reconstructed hyperprior feature is sent to a “hyperprior synthesis” module (1340) to compute the distribution parameters of the input feature. In the embodiment shown in FIG. 9, the distribution parameters include variance parameters (G) of the initial feature. In another embodiment, the distribution parameters include both the mean and the variance parameters of the initial feature.

The estimated hyperprior parameters (mean and variance) are provided to an arithmetic encoder (1350) to encode the input feature. A feature encoder with hyperprior encoder may provide higher coding performance. The “hyperprior analysis” (1310) and “hyperprior synthesis” (1340) modules are typically learnable neural network modules.

### Occupancy Probability Estimator (1130)

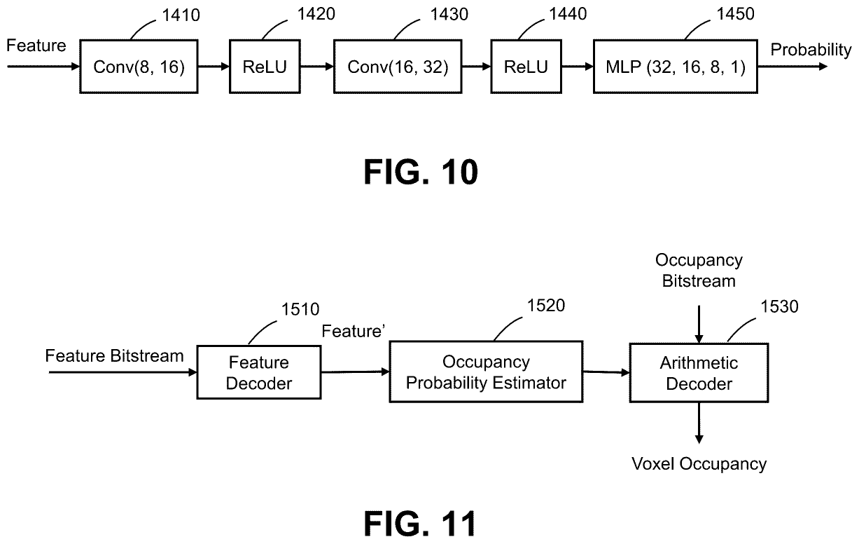

In one embodiment, an example occupancy probability estimator (OPE) is shown in FIG. 10. Firstly, the feature is further aggregated/refined by a few convolutional layers (two Conv layers, 1410, 1430), where a ReLU activation function (1420, 1440) is appended after each Conv layer to introduce non-linearity. After that, it is passed to a multilayer perceptron (MLP, 1450) to finally compute the probability. In FIG. 10, the array (32, 6, 8, 1) after MLP indicates the channel size of the MLP layers. In the end, the occupancy probability is one scalar number, therefore the output channel of the MLP is one (1).

FIG. 11 illustrates an example decoding method corresponding to the encoding method illustrated in FIG. 7, according to some embodiments. A feature decoder (FD) decodes (1510) a feature from the input bitstream. Basically, the decoder relies on a coded feature rather than to extract the feature from scratch by itself. The example decoder benefits from a more representative feature as the features were extracted using finer level of details or complete current level of detail than from the parent level. An occupancy probability estimator (OPE) computes (1520) an occupancy probability of a next octree voxel. This is the same OPE (1120) in the encoding method in FIG. 7. Based on the estimated probability, an arithmetic decoder (1530) will determine if the next octree voxel is occupied or empty.

### Feature Decoder (1510)

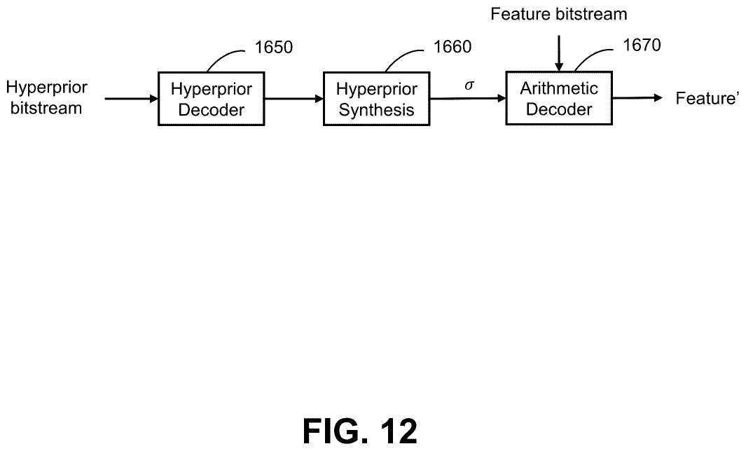

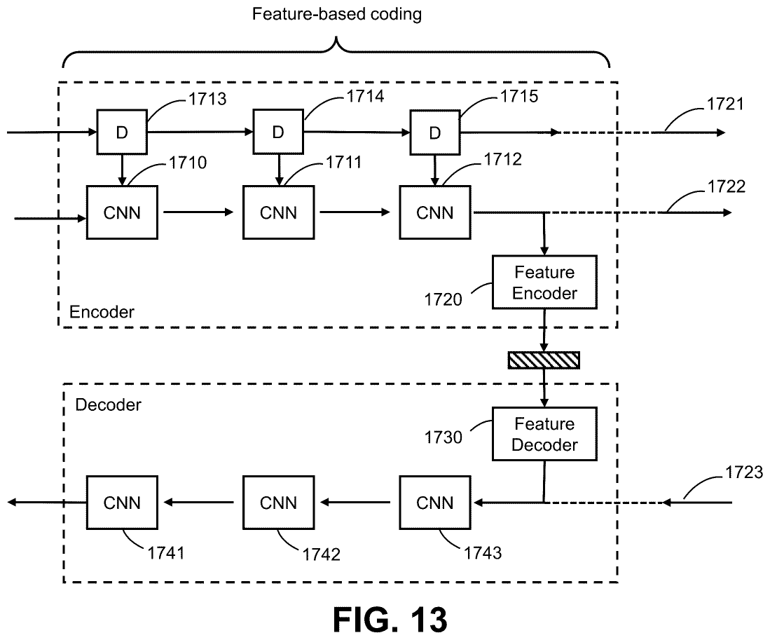

In another embodiment, an example feature decoder using hyperprior decoding is shown in FIG. 12. This decoder corresponds to the encoder as shown in FIG. 9. In particular, the coded hyperprior features is arithmetically decoded (1650) from a bitstream. The hyperprior features are sent to a “hyperprior synthesis” module (1660) to generate the distribution parameters to be used in the next step. In the embodiment shown in FIG. 12, the distribution parameters include the variance. In another embodiment, the distribution parameters include both the mean and the variance parameters. The features coded in a bitstream is arithmetically decoded (1670) based on the estimated hyperprior parameters.

Note that the “hyperprior synthesis” and “hyperprior decoder” are the same as the models at the encoder as illustrated in FIG. 9. The arithmetic decoder (1670) of feature corresponds to the feature encoder (1350) of feature at the encoder as illustrated in FIG. 9.

### Example Tree Coding in a Full Compression Framework

In the following, we present some examples regarding how example octree encoding and decoding are designed within a larger full compression framework.

In the example full point cloud compression framework, the octree-based coding is used to code the coarser level of point clouds (i.e., point cloud octree partitions) that requires lossless coding for an exact reconstruction. In one embodiment, when the example octree-based coding method is applied to code all octree levels, it leads to a lossless compression solution.

In one embodiment, the example octree-based coding is concatenated with a feature-based coding method. It leads to an overall lossy compression solution. In particular, the coarser portion of the point cloud is encoded with octree coding and the remaining finer portion of the point cloud is encoded by feature-based coding. The occupancy information output from the final level of feature-based encoding is used as input for the octree-based encoding. The occupancy information output from the final level of octree-based decoding is used as input for feature-based decoding.

### Feature-Based Coding in the Full Compression Framework

FIG. 13 illustrates a feature-based coding method. The encoder is shown in the top part of the figures. In FIG. 13, by applying “D” (1713, 1714, 1715) to the point cloud, the point cloud at a coarser level is obtained. It has a few CNN-like neural network modules (1710, 1711, 1712). They basically extract and aggregate a feature map from the input, for example, point cloud frames. During the feature extraction and aggregation, the resolution of the input is typically downsampled via pooling operations as part of the CNN-like neural network modules. Finally, the extracted feature is sent to a “Feature Encoder” (FE) module (1720) to output a bitstream.

The decoder is shown in the bottom part of the figure. A feature decoder (1730) decodes the features from the bitstream. The decoder has a few CNN-like neural network modules (1741, 1742, 1743). They correspond to the CNN-like neural network modules (with downsampling) in the encoder. Instead of performing downsampling/pooling, the CNN-like neural network modules reconstruct the input (e.g., point cloud) from the decoded features, via upsampling/unpooling. The CNN modules may be enhanced or replaced by MLP or some other neural network modules, such as the Inception ResNet (IRN) or Transformer blocks.

### Full Compression Framework, One Example

We first adopt an example octree-based compression method as shown in FIG. 7 (for encoder) and FIG. 11 (for decoder) in a full compression framework as shown in FIG. 14. In FIG. 14, we show how the example octree-based elementary encoding and decoding modules are concatenated according to some embodiments. We note that in a full compression framework combining FIG. 13 and FIG. 14, the top (1721), middle (1722), and bottom (1723) arrows of FIG. 13 are connected to the top (1811), middle (1812), and bottom (1813) arrows of FIG. 14, respectively.

In the top of FIG. 14, we show CNN-like neural network modules being concatenated to perform feature extraction and/or aggregation (1850, 1851, 1852). Each CNN represents a neural network module to generate/aggregate a feature map that is associated with a point cloud at certain resolution. This CNN module corresponds to the feature extraction/aggregation FA module in FIG. 12.

We note that the point cloud at different levels is obtained by applying a series of downsampling blocks “D” in FIG. 14, where each downsampling block “D” downsamples the point cloud by a factor of 2. In FIG. 14, by applying “D” to the point cloud at level i+1, the point cloud at level i is obtained. Additionally, by applying “D” to the point cloud at level i, the point cloud at level i−1 is obtained. Note that “O” denotes the occupancy information and “F” denotes a feature map.

In accordance with the example shown in FIG. 14, the CNNs (1850, 1851, 1852) in the top are only used during encoding and they consecutively downsample the point cloud. This is a result that in the example octree-based coding, the features extracted by the CNNs are encoded into bitstreams. In other examples the features are not coded. Instead, the decoder runs the same feature extraction as the encoder. This is reflected by the feature encoding modules FE (1860, 1861, 1862) in FIG. 14. On decoder side, the feature is decoded by modules FD (1890, 1891, 1892). The decoded feature is used to assist the octree encoding OE (occupancy encoder) modules (1870, 1871, 1872) (e.g., OPE 1130 and AE 1140 in FIG. 7) at the encoder side and octree decoding OD modules (1880, 1881, 1882) (e.g., OPE 1520 and AD 1530 in FIG. 11). For instance, to encode the octree at level i+1, a feature map at level i+1 is extracted from level i+2 via a CNN module (1850), such feature map will be further processed by another CNN module (1851) to obtain a feature map at level i to assist the coding of level i, and it will be further propagated in the same manner to assist the octree coding of other levels.

Also note that the direction to perform feature extraction by CNNs is from left to right. It indicates that the feature extraction is based on a finer level of octree. Note all voxels in the current level may also be used since the encoder has access to the whole octree. This is in contrast to other example methods that do not transmit the feature bitstream; such methods they cannot use any voxel not yet decoded for feature extraction. We note that although the feature extraction proceeds from left to right, i.e., from a finer to a coarser level, the encoding/decoding process is to be done from right to left, i.e., from a coarser level to a finer level, because the finer level occupancy information is built on top of a known coarser level. Thus, during encoding/decoding, we first perform the feature extraction from left to right. Then we perform encoding/decoding from right to left, level-by-level, based on the extracted features.

In one embodiment, the feature outputted for use at level i is generated with every voxel that are occupied at level i. In addition, features are also generated for non-occupied voxels if its parent voxel is occupied. These features are later used by octree encoding OE and octree decoding OD to compute the occupancy probabilities of all the voxels to be encoded/decoded at level i.

### Full Compression Framework, Another Example

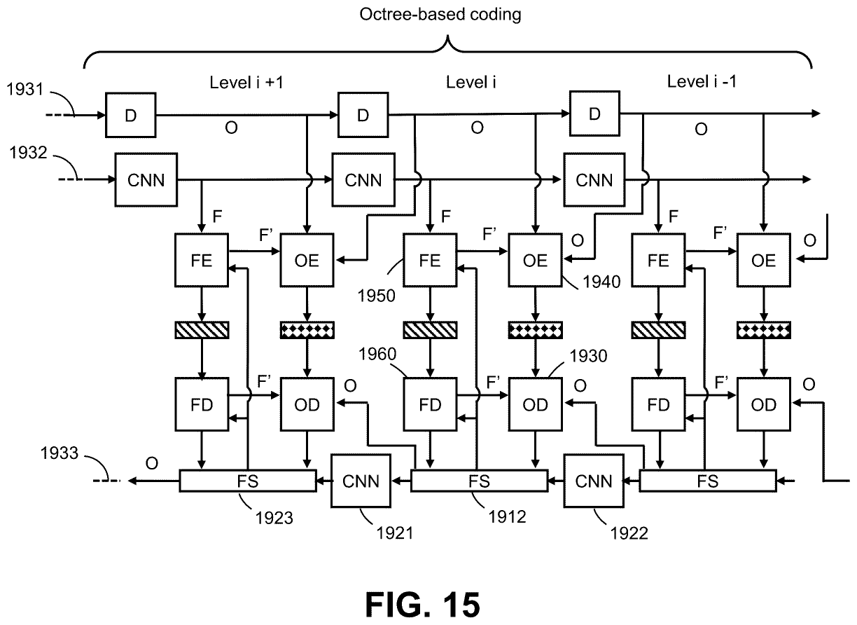

In this embodiment, another example of octree-based coding is presented in FIG. 15. This embodiment is motivated by using a different way to benefit the coding performance. We note that in a full compression framework combining FIG. 13 and FIG. 15, the top (1721), middle (1722), and bottom (1723) arrows of FIG. 13 are connected to the top (1931), middle (1932), and bottom (1933) arrows of FIG. 15, respectively.

In FIG. 15, the FS block (1912) takes the output of CNN block (1922) as input. One output of FS block (1912) is a set of estimated hyperprior parameters that is sent to feature encoding block FE (1950) and feature decoding block FD (1960). The motivation behind is to use the coded information in bitstreams from coarser levels to estimate the hyperprior parameters of the features in the current level. The idea is similar to the diagram described in FIG. 12, but the coded feature is not encoded from a hyperprior encoder but from the coded feature of the previous level. Thus, a hierarchical hyperprior model is in use to encode or decode the features.

The new FS block (1912) further takes the output of occupancy decoder OD block (1930) as its input. Finally, a second output from FS block (1912) is sent to the CNN (1921) for next level of feature aggregation.

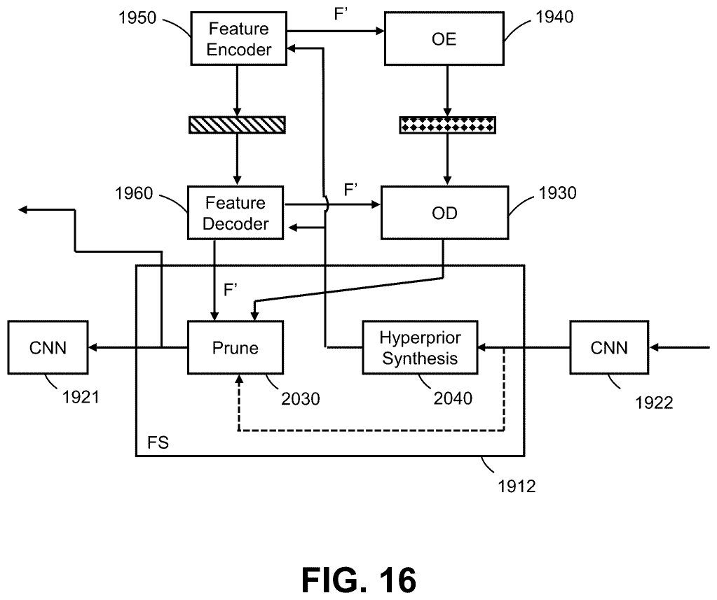

FIG. 16 shows detailed design in the FS block, according to an embodiment. First the output feature from CNN (1922) for the parent level is consumed by a hyperprior synthesis block HS (2040). The HS block outputs the hyperprior parameters, and the parameters are sent to feature encoding block FE (1950) and feature decoding block FD (1960). Then the features reconstructed from feature encoding and decoding blocks are used to assist the occupancy encoding block OE (1940) and occupancy decoding block OD (1930), respectively. We note that the FS block exists on both encoder and decoder sides. On the encoder side, it is needed to compute F′, so that F′ may be used by OE to obtain the occupancy bitstream.

The output from occupancy decoding block (1930) is the final reconstruction of point cloud at the current resolution. The reconstructed point cloud is finally used to prune (2030) the decoded features from FD block. The pruned feature is sent to the next CNN (1921) for feature aggregation when the current level is not the final level for the lossless octree coding.

In another embodiment, the prune module (2030) also takes the CNN feature as input (corresponds to the dotted line in FIG. 16). In this example, the pruning first fuses the CNN feature and the decoded feature. Then the fused feature is pruned according to the reconstructed point cloud in the current resolution.

In another embodiment, to encode or decode the feature for feature-based coding (FIG. 13), a CNN module, followed by a FS module at level i+2, are also appended after the FS module for level i+1 (1923), and the FS module at level i+2 produces hyperprior parameters to assist the encoding (1720) or decoding (1730) of the feature in the feature-based coding stage.

Point cloud content represents a 3D objects/scene with 3D points. Each point P is characterized by its position in space typically indicated by cartesian coordinates Pₓ, P_{y}, and P_{z}. Along with the positions of the 3D points, additional information or attributes may be associated with a point. Such attributes may correspond to the color, reflectance, intensity, or more characteristics per point.

A point cloud content may be compressed, resulting in a reduction of asset size. The reduced size may be beneficial for applications, such as transmission, streaming, and storage. With the advent of AI-methods and their use in compression, researchers have started to investigate methods to compress point cloud content using AI. With its popularity, MPEG 3DG WG07 has initiated a Call for Proposal (CfP) on the topic of AI-based Point Cloud Compression (AI-PCC). As such, a functional bitstream design that corresponds to the architecture of the AI-PCC codec is needed.

The '144 application describes an architecture and methods to encode point clouds in a tree structure. The encoder utilizes finer level details to extract more powerful features. The extracted features are encoded into a bitstream to benefit the decoder. The decode decodes the features instead of computing them by itself.

Some embodiments of the present application share the backbone to code features for both feature-based coding and octree-based coding. This methodology results in a unified coding framework, which in turn allows for simplicity and may result in wider adoption of the architecture. This methodology also may result in lower memory requirements.

### Spatial Segmentation of the Content

Point cloud (PC) content may be spatially segmented into smaller regions. One of the objectives of spatially segmenting the content is to allow parallelism in the encoding and decoding stages, in which smaller regions may be encoded/decoded independently. A region may or may not depend on other regions for decoding. Furthermore, this methodology enables viewport-adaptive streaming, in which regions in the viewport of the viewer may be streamed independently without the need to stream the entire content.

### Feature Coded Data

A PC may have different characteristics which may be used to describe the PC in an implicit representation. Such characteristics are often shared within the PC among different parts of the geometry and/or attributes of the PC. Such characteristics may also be called features. The features of a PC may be analyzed. The analysis may be used to determine an implicit representation of the PC which may further be compressed using learning-based methodologies.

For the '144 application, the feature extractor/aggregator uses finer (child) levels of detail as its input. Because the finer level of voxels (always) have more detailed information compared to voxels from a parent level, more representative features may be extracted more easily. In the context of PCs, a feature is a vector entity which describes the characteristics of a 3D voxel. A feature map is multi-dimensional array containing collection of features for all voxels. A geometric feature map is a 3D tensor that carries the characteristic information about the 3D geometry of the PC. The resolution of the geometric feature map is the 3D resolution of the octree at a hierarchical level. The resolution of the geometric feature map at every hierarchical level may be deduced based on the hierarchical level index and the original resolution of the input PC.

All feature vector elements at a particular index within a feature map may also be a feature channel. For example, if a feature map has a resolution of 3×3×4 with a feature vector length of 4, then there are four feature channels for each feature channel of resolution 3×3. The generated feature map at each hierarchical level is arithmetically encoded. Information related to the probability distribution of features in the feature map may either be generated by a previously decoded feature at the previous hierarchical level or by inputting some data to the arithmetic encoder while performing feature coding. In addition to generating the bitstream, the feature encoder also outputs the reconstructed feature, which may not be exactly the same as the feature from the analysis. The reconstructed feature should match the decoded features of a decoder.

### Octree Occupancy Coded Data

The '144 application discusses analyzing the features from the PC and further aggregating and/or refining them by a few convolutional layers. After that, the output is passed to a Multi-Layer Perceptron (MLP) to finally compute the probability. The occupancy probability estimator (OPE) uses a neural network model. The OPE takes the reconstructed feature as its input and determines/computes the occupancy probability of a current octree voxel. The octree coded data corresponds to the occupancy probability of a certain octree representing the PC.

### Hyperprior Data

The '144 application introduces a hyperprior. The purpose of the hyperprior is to analyze and utilize the distribution of a feature to perform efficient arithmetic coding of the feature. The feature is sent to a hyperprior analysis block to aggregate a hyperprior feature that is more abstract than the input feature. The hyperprior feature is much easier to encode. At the decoder, the encoded hyperprior feature is decoded and is used to compute the hyperprior parameters, which are later used to decode the feature.

The hyperprior features are encoded into a hyperprior bitstream. The hyperprior bitstream may undergo some quantization and arithmetic encoding. The hyperprior bitstream is arithmetically decoded and dequantized to output a reconstructed hyperprior feature.

The hyperprior encoder is more advanced than the feature encoder and may provide higher coding performance. The “hyperprior analysis” and “hyperprior synthesis” blocks are typically learnable neural network blocks for some embodiments.

### Typical Geometry Coding Framework

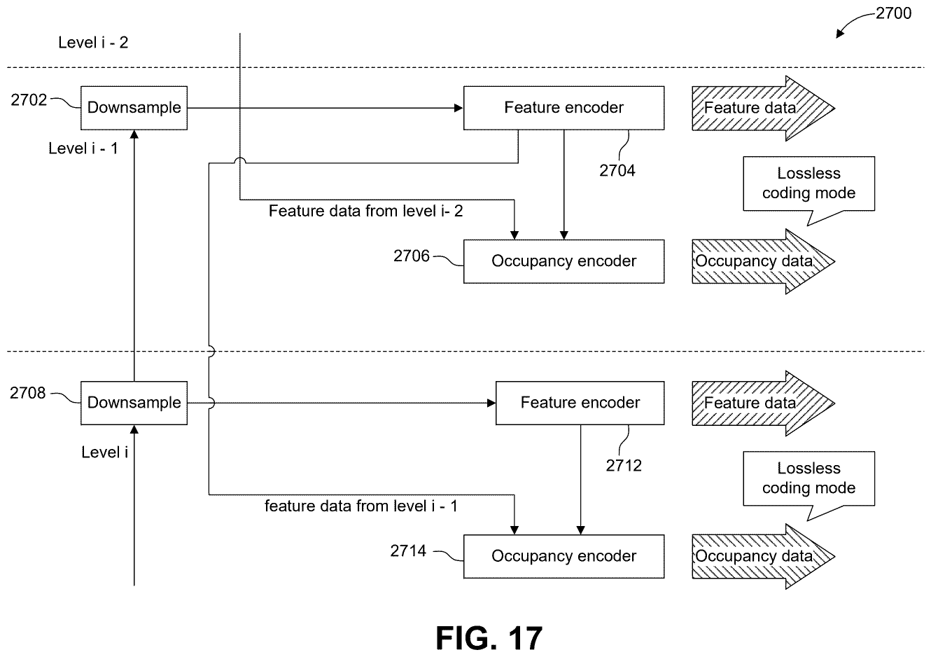

FIG. 17 is a process diagram illustrating an example coding framework with implicit hyperprior synthesis according to some embodiments. For some embodiments, the framework and interface between blocks in the codecs may differ for the '144 application.

In some cases, at a current hierarchical level, a feature map is encoded with some prior from the decoded feature data from the previous hierarchical level. At the current hierarchical level, the feature map is decoded to estimate the probability of occupancy of the current octree voxel. The probability of octree occupancy is arithmetically coded with the reconstructed feature information for each voxel at the resolution of the current hierarchical level. This coding framework 2700 is shown in FIG. 17.

For some embodiments, data for a level i is downsampled 2708 and passed through a feature encoder 2712 to generate feature data. An output of a feature encoder 2712 is passed to an occupancy encoder 2714. Data for a level i−1 is downsampled 2702 and passed through a feature encoder 2704 to generate feature data. An output of the feature encoder 2704 is passed to an occupancy encoder 2706. Each of the occupancy encoders 2706, 2714 also uses an output of a feature encoder one level up. For some embodiments, the feature encoder 2712 includes a feature aggregator. A feature aggregator is used for all levels, not just level i.

The octree occupancy data provides a lossless decoding and reconstruction of the PC. The feature data is decoded and reconstructed to generate a lossy reconstruction of the PC.

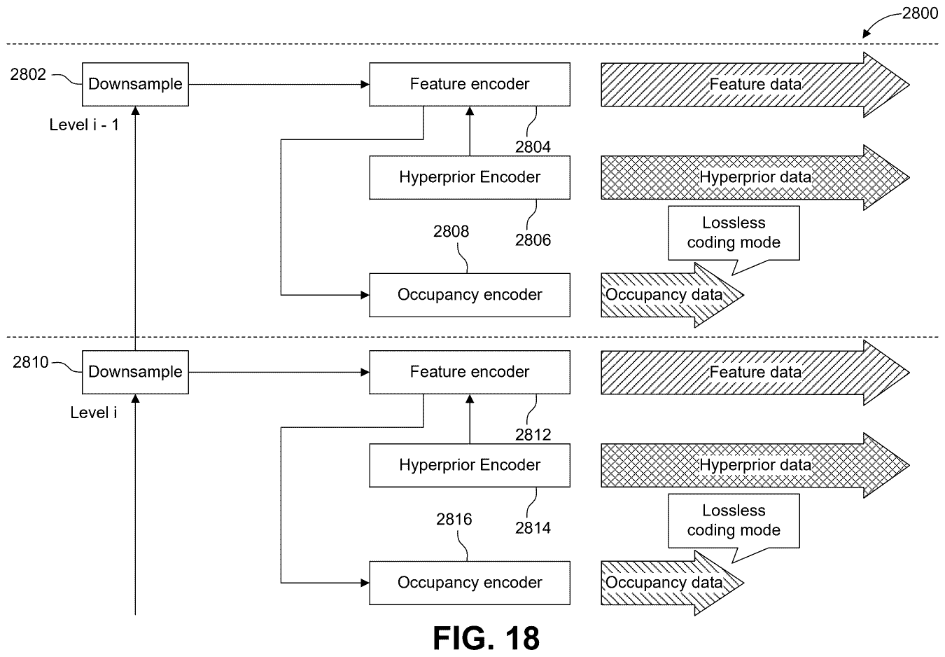

FIG. 18 is a process diagram illustrating an example coding framework with explicit hyperprior data according to some embodiments. In some embodiments of an architecture 2800, in addition to the previous architecture of FIG. 17, at a current hierarchical level prior to feature encoding, the distribution parameters, also called hyperprior parameters, of the feature are generated. The hyperprior parameters includes variance parameters of the feature. The hyperprior parameters also includes both the mean and the variance parameters of the feature. The estimated hyperprior parameters (mean and variance) are provided to an arithmetic encoder to encode the feature at the current level. The hyperprior data is signaled by the encoder 2814, 2806 to the feature encoder 2812, 2804 to reduce the complexity of the decoder by removing the need for reconstructing the hyperprior from the previous decoded feature at the previous hierarchical level. Therefore, this methodology may result in a simplified decoder design for some embodiments. The hyperprior data is coded with the same resolution as the feature map.

For some embodiments, data for a level i is downsampled 2810 and passed through a feature encoder 2812 to generate feature data. An output of a feature encoder 2812 is passed to an occupancy encoder 2816. Data for a level i−1 is downsampled 2802 and passed through a feature encoder 2804 to generate feature data. An output of the feature encoder 2804 is passed to an occupancy encoder 2808.

As discussed with regard to FIG. 17, the octree occupancy data enables a lossless decoding and reconstruction of the PC. The feature data along with the hyperprior data is decoded and reconstructed to generate a lossy reconstruction of the PC.

### Typical Attribute Coding Framework

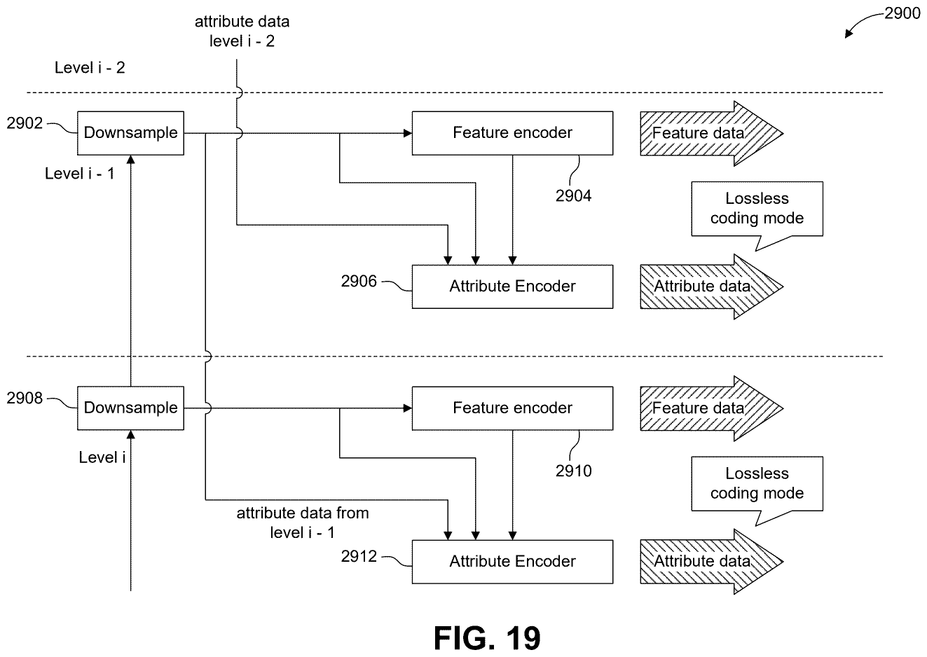

FIG. 19 is a process diagram illustrating an example attribute encoding framework according to some embodiments. For the '144 application, a typical attribute coding framework uses a learning-based method to code the attribute information of the point cloud. As shown in FIG. 19, attributes of the PC may be coded using a similar coding framework 2900 as used for coding the geometry. Geometry coding and attribute coding may differ in two ways. An attribute coding framework relies on the decoded geometry data to encode the attribute information. In place of an occupancy estimator, a distribution parameter estimator block is used to determine the distribution probability of the attribute elements in a slice.

For some embodiments, data for a level i is downsampled 2908 and passed through a feature encoder 2910 to generate feature data. An output of a feature encoder 2910 is passed to an attribute encoder 2912. The attribute encoder 2912 also receives as an input the input to the feature encoder 2910 and the input to the feature encoder 2904 for the i−1 level.

For some embodiments, data for a level i−1 is downsampled 2902 and passed through a feature encoder 2904 to generate feature data. An output of a feature encoder 2904 is passed to an attribute encoder 2906. The attribute encoder 2906 also receives as an input the input to the feature encoder 2904 and the input to the feature encoder for the i−2 level.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a first bitstream comprising a plurality of encoded data samples; obtaining a second bitstream comprising a safeguard syntax structure; decoding the plurality of data samples; obtaining safeguard payload information from the safeguard syntax structure, wherein the safeguard payload information comprises a maximum tolerance error (MTE) and information regarding a set of risky samples; and performing a protection process on the decoded plurality of data samples using the safeguard payload information.

For some embodiments of the first example method, the set of risky samples is a subset of the plurality of data samples.

For some embodiments of the first example method, the safeguard syntax structure comprises sample values for each member of a set of risky samples.

For some embodiments of the first example method, the safeguard syntax structure comprises a flag for each of the plurality of data samples, and each of the flags indicates whether the corresponding data sample is a member of the set of risky samples.

For some embodiments of the first example method, the safeguard syntax structure comprises a supplemental enhancement information (SEI) message.

For some embodiments of the first example method, the MTE applies to at least one of a sequence parameter set, a frame parameter set, a set of blocks, a block, a set of slices, and a slice corresponding to at least one of the plurality of data samples.

Some embodiments of the first example method may further include overriding the MTE with an override value based on a status parameter corresponding to at least one of the plurality of data samples.

For some embodiments of the first example method, the status parameter is an override flag.

For some embodiments of the first example method, performing the protection process on the decoded plurality of data samples comprises determining whether at least one of the decoded plurality of data samples is within the MTE for decoding.

For some embodiments of the first example method, performing the protection process on the decoded plurality of data samples changes a value of at least one of the plurality of data samples.

A first example apparatus in accordance with some embodiments may include: a processor; and a memory storing instructions operative, when executed by the processor, to cause the apparatus to: obtain a first bitstream comprising a plurality of encoded data samples; obtain a second bitstream comprising a safeguard syntax structure; decode the plurality of data samples; obtain safeguard payload information from the safeguard syntax structure, wherein the safeguard payload information comprises a maximum tolerance error (MTE) and information regarding a set of risky samples; and perform a protection process on the decoded plurality of data samples using the safeguard payload information.

A second example method in accordance with some embodiments may include: obtaining a plurality of data samples and information regarding a safeguard payload, wherein the safeguard payload information comprises a maximum tolerance error (MTE) and information regarding a set of risky samples; generating a transmitting the encoded plurality of data samples in a first bitstream; and transmitting the safeguard syntax structure in a second bitstream.

For some embodiments of the second example method, the set of risky samples is a subset of the plurality of data samples.

For some embodiments of the second example method, the safeguard syntax structure comprises sample values for each member of the set of risky samples.

For some embodiments of the second example method, the safeguard syntax structure comprises a flag for each of the plurality of data samples, and each of the flags indicates whether the corresponding data sample is a member of the set of risky samples.

For some embodiments of the second example method, the safeguard syntax structure comprises a supplemental enhancement information (SEI) message.

For some embodiments of the second example method, the MTE applies to at least one of a sequence parameter set, a frame parameter set, a set of blocks, a block, a set of slices, and a slice corresponding to at least one of the plurality of data samples.

Some embodiments of the second example method may further include overriding the MTE with an override value based on a status parameter corresponding to at least one of the plurality of data samples.

For some embodiments of the second example method, the status parameter is an override flag.

For some embodiments of the second example method, the plurality of data samples comprises a point cloud.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining a first bitstream comprising a plurality of encoded data samples;
obtaining a second bitstream comprising a safeguard syntax structure;
decoding the plurality of data samples;
obtaining safeguard payload information from the safeguard syntax structure,
wherein the safeguard payload information comprises a maximum tolerance error (MTE) and information regarding a set of risky samples; and
performing a protection process on the decoded plurality of data samples using the safeguard payload information.

2. The method of claim 1, wherein the set of risky samples is a subset of the plurality of data samples.

3. The method of claim 1, wherein the safeguard syntax structure comprises sample values for each member of a set of risky samples.

4. The method of claim 1,
wherein the safeguard syntax structure comprises a flag for each of the plurality of data samples, and
wherein each of the flags indicates whether the corresponding data sample is a member of the set of risky samples.

5. The method of claim 1, wherein the safeguard syntax structure comprises a supplemental enhancement information (SEI) message.

6. The method of claim 1, wherein the MTE applies to at least one of a sequence parameter set, a frame parameter set, a set of blocks, a block, a set of slices, and a slice corresponding to at least one of the plurality of data samples.

7. The method of claim 1, further comprising overriding the MTE with an override value based on a status parameter corresponding to at least one of the plurality of data samples.

8. The method of claim 7, wherein the status parameter is an override flag.

9. The method of claim 1, wherein performing the protection process on the decoded plurality of data samples comprises determining whether at least one of the decoded plurality of data samples is within the MTE for decoding.

10. The method of claim 1, wherein performing the protection process on the decoded plurality of data samples changes a value of at least one of the plurality of data samples.

11. An apparatus comprising:
a processor; and
a memory storing instructions operative, when executed by the processor, to cause the apparatus to:
obtain a first bitstream comprising a plurality of encoded data samples;
obtain a second bitstream comprising a safeguard syntax structure;
decode the plurality of data samples;
obtain safeguard payload information from the safeguard syntax structure,
wherein the safeguard payload information comprises a maximum tolerance error (MTE) and information regarding a set of risky samples; and
perform a protection process on the decoded plurality of data samples using the safeguard payload information.

12. A method comprising:
obtaining a plurality of data samples and information regarding a safeguard payload,
wherein the safeguard payload information comprises a maximum tolerance error (MTE) and information regarding a set of risky samples;
generating a safeguard syntax structure using the safeguard payload information;
encoding the plurality of data samples;
transmitting the encoded plurality of data samples in a first bitstream; and
transmitting the safeguard syntax structure in a second bitstream.

13. The method of claim 12, wherein the set of risky samples is a subset of the plurality of data samples.

14. The method of claim 12, wherein the safeguard syntax structure comprises sample values for each member of the set of risky samples.

15. The method of claim 12,
wherein the safeguard syntax structure comprises a flag for each of the plurality of data samples, and
wherein each of the flags indicates whether the corresponding data sample is a member of the set of risky samples.

16. The method of claim 12, wherein the safeguard syntax structure comprises a supplemental enhancement information (SEI) message.

17. The method of claim 12, wherein the MTE applies to at least one of a sequence parameter set, a frame parameter set, a set of blocks, a block, a set of slices, and a slice corresponding to at least one of the plurality of data samples.

18. The method of claim 12, further comprising overriding the MTE with an override value based on a status parameter corresponding to at least one of the plurality of data samples.

19. The method of claim 18, wherein the status parameter is an override flag.

20. The method of claim 12, wherein the plurality of data samples comprises a point cloud.
